(19) United States
(12) Patent Application Publication
(10) Pub. No.: US 2010/0024526 A1
(43) Pub. Date: Feb. 4, 2010

(54) SYSTEMS AND METHODS FOR OPTICAL MEASUREMENT OF ANALYTE CONCENTRATION

(75) Inventors: Arthur E. Colvin, JR., Mt. Airy, MD (US); Andrew DeHennis, Germantown, MD (US)

Correspondence Address: ROTHWELL, FIGG, ERNST & MANBECK, P.C., 1425 K STREET, N.W., SUITE 800, WASHINGTON, DC, 20005, US

(73) Assignee: Sensors for Medicine & Science, Inc., Germantown, MD (US)

(21) Appl. No.: 12/508,727

(22) Filed: Jul. 24, 2009

Related U.S. Application Data
(60) Provisional application No. 61/084,100, filed on Jul. 28, 2008.

(51) Int. Cl. G01N 21/00

(52) U.S. Cl. 73/61.48

(57) ABSTRACT

A method and sensor for measuring the concentration of an analyte about radiantly excitable indicator molecules. A stimulus waveform is used to drive a radiant source. The indicator molecules are exposed to the radiant source. A response waveform is generated to represent photoluminescent radiation emitted by the indicator molecules. A phase difference between the stimulus waveform and the response waveform is a function of the concentration of the analyte that enables determining the analyte concentration.

### CROSS REFERENCE TO RELATED APPLICATION

This application claims the benefit of Provisional Application Ser. No. 61/084,100, filed on Jul. 28, 2008, the contents of which is incorporated herein by reference in its entirety.

### BACKGROUND

1. Field of the Invention

The invention relates to systems and methods of measuring analyte concentrations. More particularly, the invention relates to a miniature sensor and sensor interface module that enable measurement of analyte concentrations using a phase-based protocol.

2. Discussion of Related Art

Photoluminescence sensing has been used to measure emission characteristics of an optical sensor based on excitation of the sensor by a radiation source. Photoluminescence sensing can be used, for example, to measure a photoluminescence lifetime of a fluorophore, a concentration of an analyte, photoluminescence intensity or other chemical parameter. Devices that use photoluminescence sensing to detect these parameters typically use an amplitude-based, time-based or phase-based protocol to obtain the desired parameter.

Such devices are typically bulky, expensive, and not easily transported. These devices may cost about US $10,000 and may be approximately the size of a large screen cathode ray tube television and include multiple pieces of equipment. Although some of these devices are marketed as portable, moving equipment such as two-shelf lab carts are typically required to transport these devices to various locations. This is due at least in part to expansive circuits and complex data processing that, combined with significant know-how, are required to obtain a desired result. Additionally, these devices typically require a large amount of power to operate.

These and other drawbacks of current systems exist.

### SUMMARY OF THE INVENTION

The invention relates to devices and methods of measuring the concentration of an analyte. More particularly, the invention relates to a sensor and a sensor interface module (SIM) that communicates with the sensor to measure the concentration of an analyte in a medium. The sensor and SIM may be used in various gaseous environments such as, for example, biochemical oxygen demand, inerting, combustion, environmental, chemical, diving/life support, and medical applications such as anesthesiology, respiration, and oxygen concentrators. The sensor and SIM may also be used in various submerged environments such as, for example, biochemical oxygen demand, implantable sensors, fish farming, aquariums, pollution monitoring, chemical processing, and brewing/fermentation. Each of these applications may be used to determine a concentration of various analytes such as, for example, oxygen, glucose, carbon dioxide, toxins or temperature, in a medium such as, for example, air, blood, water or other gaseous or liquid medium.

According to one embodiment, the invention includes an optical sensor and a sensor interface module (SIM). The sensor includes a radiant source, photoelectric transducer, and indicator molecules. The sensor interface module includes a microcontroller that communicates with the sensor to drive the radiant source and receive data obtained by the sensor. The microcontroller causes the radiant source to irradiate the indicator molecules. The indicator molecules luminesce due to light emitted by the radiant source and exhibit certain characteristics based on an analyte present in the medium. The sensor transmits data relating to this luminescence to the microcontroller for processing. Based on the data received, known data, and the Stern-Volmer relationship, the microcontroller determines a concentration of the analyte. According to one embodiment of the invention, the sensor interface module includes an interface that enables the module to transmit the data to an external data system so that the data may be presented to a system user.

In one aspect, the invention provides a device for measuring an analyte concentration having a microcontroller configured to output a periodic digital signal of a predetermined frequency on a digital output bus of a microcontroller and compute a phase difference between a stimulus waveform and a response waveform present on analog inputs of the microcontroller.

The device also includes a digital-to-analog converter to convert the periodic digital signal to a periodic voltage waveform, a low pass filter to smooth the periodic voltage waveform and output the stimulus waveform, and a voltage-to-current converter operable to convert the stimulus waveform to a periodic current waveform and to drive a radiant source wherein the radiant source radiates onto indicator molecules.

The device further includes a bandpass transimpedance amplifier to convert a current from a photoelectric transducer to the response voltage waveform. Radiation from the indicator molecules is incident on the photoelectric transducer and the phase difference is a function of an analyte concentration local to the indicator molecules.

According to one embodiment of the invention, a method is provided that measures a concentration of an analyte within a medium. The method uses a sensor that is provided with a plurality of indicator molecules. The indicator molecules exhibit a predetermined characteristic when in the presence of a particular analyte. The sensor generates a stimulus waveform that is used to drive an excitation source.

The indicator molecules are excited by the excitation source, based on a type of sensor used, to exhibit the characteristic associated with the analyte for which a concentration determination is desired. A response waveform for the characteristic exhibited is generated as a representation of the characteristic. The stimulus waveform and the response waveform are oversampled and a phase delay, which is dependent on the concentration of the analyte, is determined. The analyte concentration may then be determined using the phase delay determined and the Stern-Volmer relationship.

According to another embodiment of the invention, a method for determining the concentration of an analyte includes a step of creating a periodic digital output signal on a microcontroller output. The periodic digital output signal is converted into a smoothed driver current waveform, where the smoothed driver current waveform is of the same frequency as the periodic digital output signal.

The method also includes the steps of driving a radiant source with the smoothed driver current, where the radiation from the radiant source is incident on indicator molecules, detecting radiant excitation energy of the indicator molecules with a photoelectric transducer, where the photoelectric transducer outputs a waveform of the same frequency of the smoothed driver current waveform, and measuring a phase difference between the smoothed driver current waveform and the outputted photoelectric transducer waveform. The phase difference correlates to an analyte concentration local to the indicator molecules.

The above and other features and advantages of the invention, as well as the structure and operation of preferred embodiments of the invention, are described in detail below with reference to the accompanying drawings.

### BRIEF DESCRIPTION OF THE DRAWINGS

The accompanying drawings, which are incorporated herein and form part of the specification, illustrate various embodiments of the invention and, together with the description, further serve to explain the principles of the invention and to enable a person of ordinary skill in the pertinent art to make and use the invention.

FIG. 1 is a schematic diagram of a system of measuring analyte concentrations in accordance with one embodiment of the invention.

FIG. 2 is a schematic diagram of a sensor interface module in accordance with one embodiment of the invention.

FIGS. 3 and 4 are a top and section views, respectively, of a photoluminescence-based sensor in accordance with one embodiment of the invention.

FIG. 5 is a flowchart illustrating a method of measuring an analyte concentration in accordance with one embodiment of the invention.

FIG. 6 is a flowchart illustrating a method of measuring an analyte concentration in accordance with one embodiment of the invention.

FIGS. 7A-7E illustrate exemplary waveforms present at certain points in a circuit of a device used for measuring analyte concentration in accordance with one embodiment of the invention.

FIG. 8 is an illustration of a photoluminescence-based sensor in accordance with one embodiment of the invention.

### DETAILED DESCRIPTION OF PREFERRED EMBODIMENTS

According to one embodiment, the invention relates to a system and method of measuring analyte concentrations. The system and method use an optical sensor and a sensor interface module (SIM) to measure a concentration of an analyte using photoluminescence. The sensor and SIM communicate and process photoluminescent information in a way that enables the sensor and SIM to be very small and portable. In some embodiments, the sensor and the SIM are small enough to fit in a palm of a person's hand, and can even be smaller.

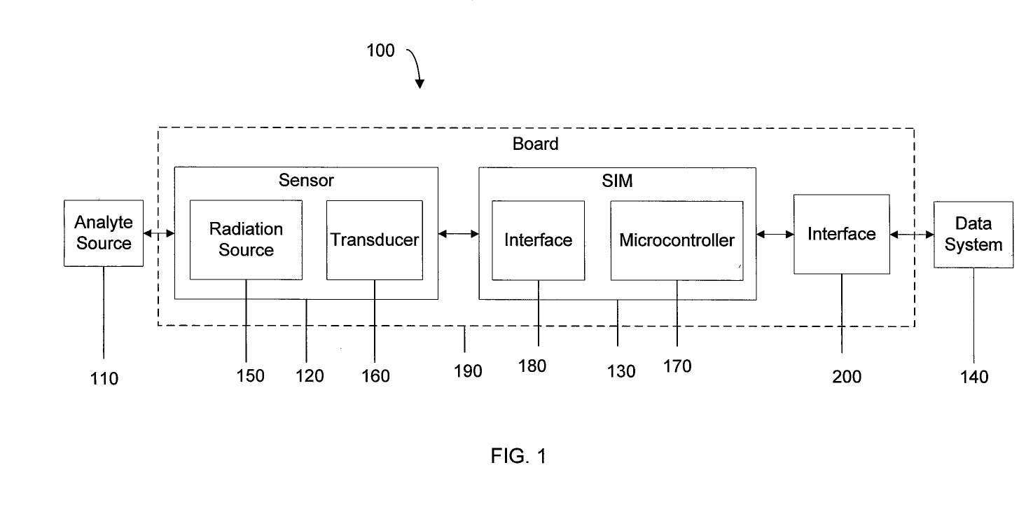

FIG. 1 is a schematic illustration of a device 100 for measuring an analyte concentration according to one embodiment of the invention. Device 100 includes an analyte source 110, sensor 120, sensor interface module (SIM) 130, and data system 140. Analyte source 110 may be, for example, a medium that includes an analyte for which a concentration measurement is desired. The medium may be, for example, air, blood, water or other gaseous or liquid medium. Sensor 120 is preferably an optical sensor that uses fluorescent indicator molecules (described in further detail below) to enable measuring of concentrations of analytes such as, for example, oxygen, glucose, and toxin within the medium. According to one embodiment of the invention, sensor 120 may communicate with SIM 130 using any known wire or wireless connection. Sensor 120 may communicate with SIM 130 to measure, for example, oxygen concentrations in a gaseous medium or in the blood of a patient in whom sensor 120 has been implanted. Data system 140 may be, for example, a data collection system, a microprocessor, or a microcomputer.

Sensor 120 preferably includes a radiation source 150 and a transducer 160. According to one embodiment, radiation source 150 includes a light emitting diode (LED) that irradiates a medium containing an analyte. Sensor 120 obtains instructions for controlling radiation source 150 from a microcontroller 170 and transmits data obtained to microcontroller 170 for processing. Sensor 120 communicates with SIM 130 using an interface 180. Transducer 160 converts analog information received by sensor 120 to data that is processed by microcontroller 170.

According to one embodiment of the invention, sensor 120 and SIM 130 may be provided on a circuit board 190 that enables testing, calibration, and other functions to be performed by device 100. Circuit board 190 includes an interface 200 that enables communication between SIM 130 and data system 140. SIM 130 may communicate with data system 140 to enable readings, measurements, and other data obtained or generated by sensor 120 and SIM 130 to be processed, displayed or stored by data system 140.

As discussed above, sensor 120 and SIM 130 preferably are of a size that fit into a palm of a person's hand, and can even be smaller. According to one non-limiting embodiment, SIM 130 occupies a space of approximately 0.34 cubic inches or less and sensor 120 occupies a space of approximately 0.009 cubic inches or less, has a direct current (DC) root mean square (RMS) power consumption in a range of approximately 1 to 200 milliamps, responds to analyte concentration changes in less than approximately one-hundred (100) milliseconds (ms) or less, and operates in ambient pressures from vacuum level ranges to thousands of pounds per square inch (psi).

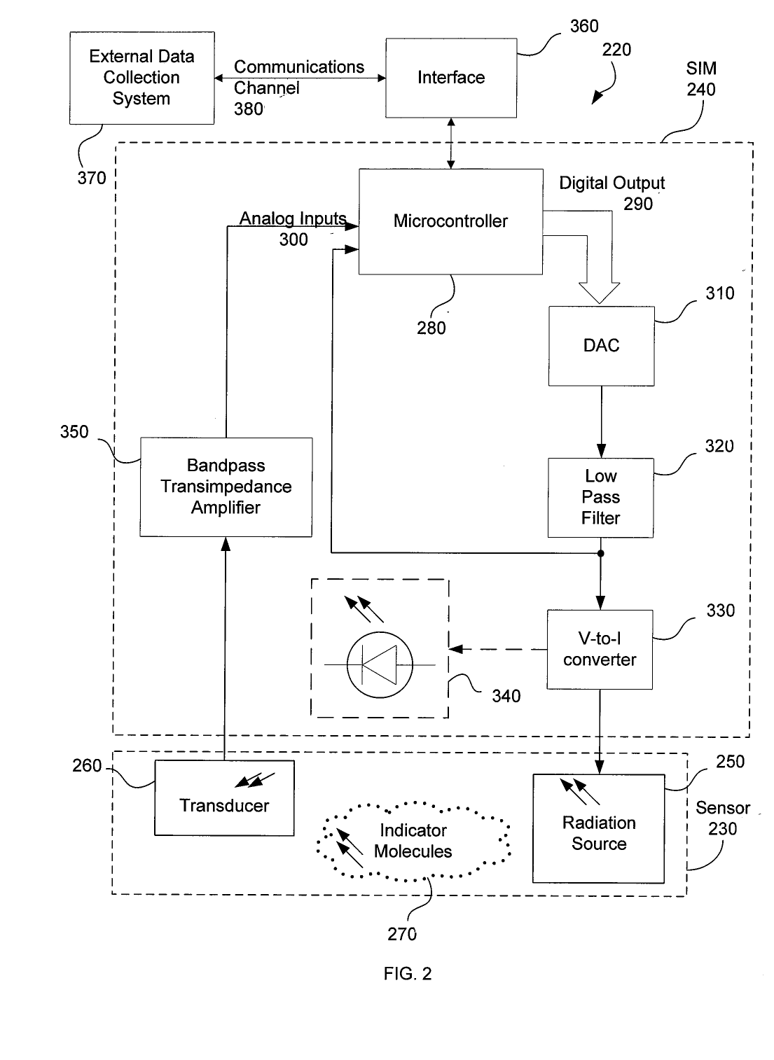

FIG. 2 is a schematic illustration of a device 220 for measuring analyte concentrations according to one embodiment of the invention. Device 220 includes a sensor 230 and a sensor interface module (SIM) 240. Sensor 230 is provided within a medium containing an analyte for which a concentration measurement is desired. Sensor 230 and SIM 240 communicate with each other regarding data used to determine the analyte concentration. Sensor 230 includes a radiation source 250, transducer 260, and indicator molecules 270 and is described in further detail below.

Sensor interface module (SIM) 240 includes a microcontroller 280. Microcontroller 280 generates excitation signals that are used to drive radiation source 250 that causes indicator molecules 270 to luminesce. According to one embodiment of the invention, indicator molecules 270 may be the complex tris (4,7-diphenyl-1,10-phenanthroline) ruthenium(II) perchlorate, lanthanide-based indicators such as europium or terbium complexes, aromatic hydrocarbons or any indicator or molecular transduction system for an analyte that has a sufficiently long luminescent lifetime to allow for a detectable difference when measured with phase modulation. Examples of analytes include, but are not limited to, oxygen, carbon dioxide, glucose, and temperature.

Radiation source 250 may vary depending on a type of indicator used. For example, if the indicator is the complex tris (4,7-diphenyl-1,10-phenanthroline) ruthenium(II) perchlorate, which has a decay time of approximately four (4) milliseconds, a blue light-emitting diode (LED) may be used. This is because light emission from a blue LED has a peak wavelength of approximately 460 nanometers which matches well with the optimal excitation spectrum of the complex tris (4,7-diphenyl-1,10-phenanthroline) ruthenium(II) perchlorate. Other LEDs such as green and red LEDs or other radiation sources also may be used. In general, radiation sources or LEDs are preferred that have a peak emission that is matched with the optimal excitation spectrum of the indicator. If a lanthanide indicator is used, a violet LED that has a peak emission wavelength of approximately 360-380 nanometers may be used. An example of a lanthanide-based indicator is described in U.S. Pat. No. 6,344,360 which is hereby incorporated by reference in its entirety. Additional examples of indicator molecules are described in U.S. Pat. No. 5,517,313 which is hereby incorporated by reference in its entirety.

The excitation signals are generated based on parameters processed by microcontroller 280. The excitation signals are based on known characteristics exhibited by the analyte being measured. This provides a reference signal against which measured signals may be compared (described in further detail below). According to one embodiment, microcontroller 280 is configured to have a digital output channel 290 and one or more analog input channels 300. Digital output channel 290 may be used to transmit the excitation signals to radiation source 250 of sensor 230. Analog input channels 300 may be used to receive signals transmitted by transducer 260 of sensor 230. Microcontrollers, such as those in the PIC24 family from Microchip Technology Inc., or other compatible microcontrollers, may be used as microcontroller 280. According to one embodiment of the invention, microcontroller 280 includes a digital signal processor.

Sensor interface module (SIM) 240 further includes digital-to-analog converter (DAC) 310 for converting signals transmitted using digital output channel 290 of microcontroller 280 into an analog voltage. In one embodiment, digital output channel 290 of microcontroller 280 is a 4-bit bus having bit₀ . . . bit₃ and digital-to-analog converter 310 is a simple resistor ladder. In one exemplary, non-limiting embodiment, digital-to-analog converter 310 includes a 111 kΩ resistor connected to bit₃, a 270 kΩ resistor connected to bit₂, a 400 kΩ resistor connected to bit₁, and a 800 kΩ resistor connected to bit₀. The output of digital-to-analog converter 310 is a node to which each resistor lead (the lead opposite the microcontroller) is connected. Other resistor ladders and networks known to those of ordinary skill in the art may be used as digital-to-analog converter 310. Furthermore, digital-to-analog converter 310 may be implemented on an integrated circuit.

Sensor interface module (SIM) 240 further comprises low-pass filter 320 that converts a voltage waveform output from digital-to-analog converter 310 into a sine wave approximation of the voltage waveform output. Low-pass filter 320 may be a resistor-capacitor (RC) design known to those of ordinary skill in the art. In one exemplary embodiment, resistance (R) and capacitance (C) are selected to pass a signal at frequency f, for example, 10 kHz, and suppress any higher frequency noise sources. The voltage waveform output of low-pass filter 320 is transmitted to analog input 300 of microcontroller 280. Low-pass filter 320 may include a variable capacitance capacitor. According to one non-limiting embodiment of the invention, the capacitor and resistor forming the low-pass filter may have values of approximately 470 pF and 15 kΩ, respectively.

Sensor interface module (SIM) 240 further includes voltage-to-current converter 330. In one embodiment, voltage-to-current converter 330 converts its input, the sine wave approximation of the voltage waveform output of low-pass filter 320, into a current proportional to the input voltage. The output of voltage-to-current converter 330 includes excitation signals that drive radiation source 250. Radiation source 250 is situated so that its radiant output reaches indicator molecules 270. Light emitted by radiation source 250 causes indicator molecules 270 to luminesce in a particular manner based on a presence of the analyte being measured. This luminescence is detected as signals by transducer 260. Transducer 260 outputs a signal that is a function of the luminescence irradiating from indicator molecules 270. Transducer 260 may be, for example, a photodiode, a phototransistor, a photomultiplier or other photodetector.

Voltage-to-current converter 330 may optionally be in communication with a current mirror that mirrors the current driving radiation source 250 for driving a light-emitting diode (LED) 340. In one embodiment, LED 340 is a red LED which may be used for testing sensor interface module (SIM) 240.

The output of transducer 260 is connected to a bandpass transimpedance amplifier 350. Bandpass transimpedance amplifier 350 includes a bandpass gain response and generates a voltage waveform that is a function of its current input. The output of bandpass transimpedance amplifier 350 is transmitted to an analog input 300 of microcontroller 280.

Device 220 may also include a communication interface 360 that enables microcontroller 280 to transmit and receive data regarding analyte concentrations to an external data system 370. Microcontroller 280 and data system 370 may communicate over a communications channel 380 such as, for example, a microcontroller serial channel. Data system 370 may be, for example, a data collection system, a microprocessor, a microcomputer or other device.

Microcontroller 280, using, for example, a stored program, may be configured to: receive and act on command codes transmitted through its communications channel 380, generate a periodically changing digital output, sample voltages on analog inputs, and compute and transmit data related to analyte concentrations through communications channel 380. Sensor interface module (SIM) 240 may be set to take a single measurement or to run continuously, repeating measurements after a specified delay.

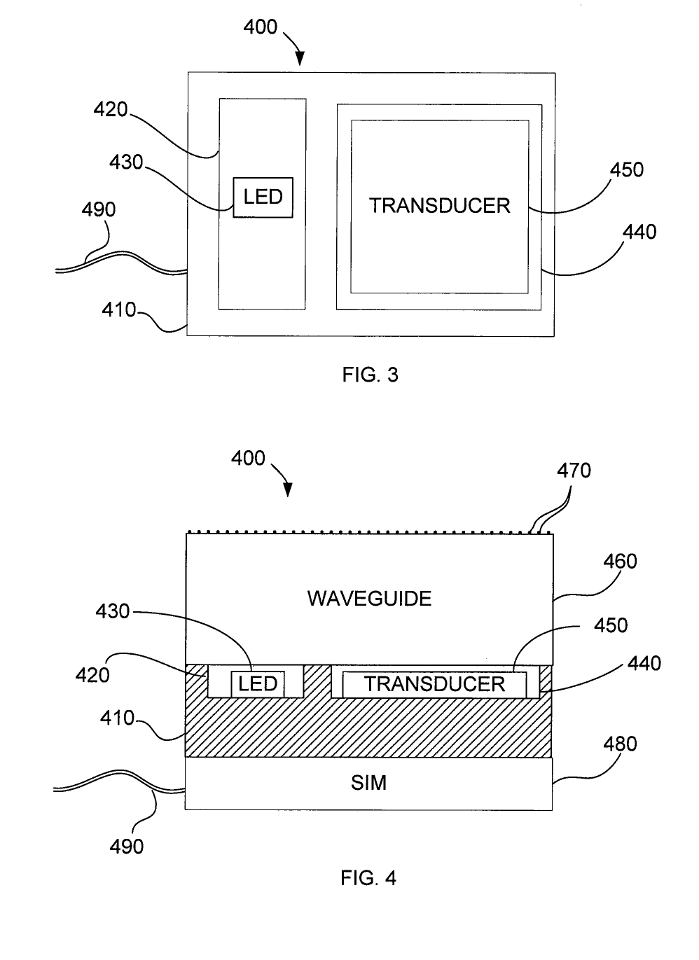

FIGS. 3 and 4 are plan and sectional views, respectively, of a sensor 400 according to one embodiment of the invention. Sensor 400 may be, for example, an optical sensor. Sensor 400 includes a substrate 410 configured with a well 420 for a radiant source 430 and a well 440 for a photoelectric transducer 450. Radiant source 430 may be, for example, a light-emitting diode (LED) and transducer 450 may be, for example, a photoelectric transducer, photodiode or other transducer. Among other advantages, this configuration reduces direct illumination of transducer 450 by radiant source 430.

Sensor 400 may further include a waveguide 460 that optimizes transmissive and reflective characteristics of sensor 400. In one embodiment, indicator molecules 470 are located on at least a portion of the upper surface of waveguide 460. A sensor interface module (SIM) 480 is situated in proximity to radiation source 430 and transducer 450. A communications channel 490 may connect sensor 400 with an external data system (shown in FIG. 2). In other embodiments, the sensor 400 wirelessly communicates with the external data system.

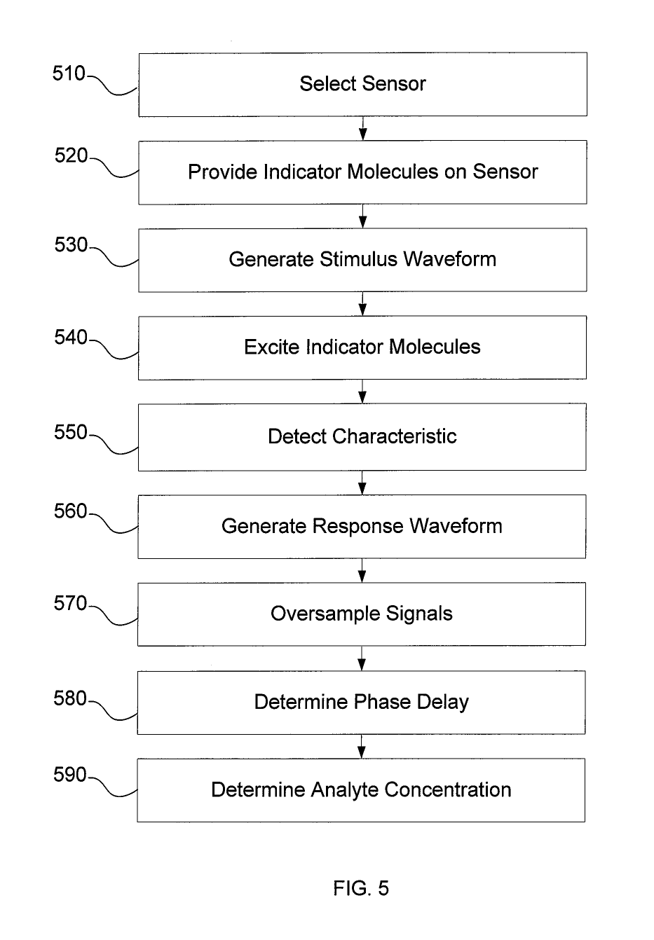

FIG. 5 illustrates a method of measuring an analyte concentration according to one embodiment of the invention. The method includes selecting a type of sensor, step 510, to be used for determining a particular characteristic of an analyte. For example, an optical sensor may be used to sense the concentration of oxygen in a patient's blood.

Indicator molecules are provided on the sensor at step 520. The indicator molecules preferably react to an analyte characteristic capable of detection by the sensor. For example, a radiation source may be used to excite the indicator molecules such that the indicator molecules luminescence is detected by the optical sensor. For example, a blue light emitting diode (LED) may be used to excite complex tris (4,7-diphenyl-1,10-phenanthroline) ruthenium(II) perchlorate indicator molecules.

A stimulus waveform is generated at step 530 based on the type of analyte for which a concentration measurement is desired. If an optical sensor is used, for example, this may include using the stimulus waveform to direct an LED to emit radiation having a predetermined form. A device for which a particular characteristic may be detected by the sensor is used to excite the indicator molecules at step 540. The device may be, for example, a radiation source if an optical sensor is being used.

The sensor then detects the characteristic exhibited by the indicator molecules at step 550. If an optical sensor and a radiation source are used, the optical sensor detects photoluminescent radiation emitted by the indicator molecules. The photoluminescent radiation is received by a filter of the sensor and is transduced by a photodiode of the sensor. A response waveform is generated at step 560 based on the characteristic of the indicator molecules received, such as, for example, photoluminescent radiation received from the indicator molecules. In the optical sensor example, current from the photodiode is of the same form as that of the stimulus waveform, only phase delayed.

The stimulus and response waveforms generated are then oversampled at step 570 such that a phase delay between the waveforms may be determined at step 580. Using the phase delay, analyte concentration may be determined at step 590. This is because the phase delay is proportional to the analyte concentration. In particular, fluorescing molecules will fluoresce for a known period of time, a decay time or excited state lifetime after removal of a radiant stimulus. Both the intensity of the fluorescence and the decay time vary according to a linear relationship with the concentration of a given fluorescence quencher. In one non-limiting example, the concentration of the analyte of interest can be determined from phase delay based on the relationship described in the Stern-Volmer equation:

$$\frac{{τ}_{0}}{τ} = \frac{{I}_{o}}{I} = 1 + {K}_{sv} [ Q ]$$

where τ is the decay time and I is the intensity of the fluorescence in the presence of the quencher Q, τ₀ is the decay time and I₀ is the intensity of the fluorescence in the absence of the quencher Q, Ksv is the Stern-Volmer Quenching Constant and [Q] is the concentration of the quencher Q. Thus, if τ can be measured, the concentration of Q can be determined through the Stern-Volmer equation, for example.

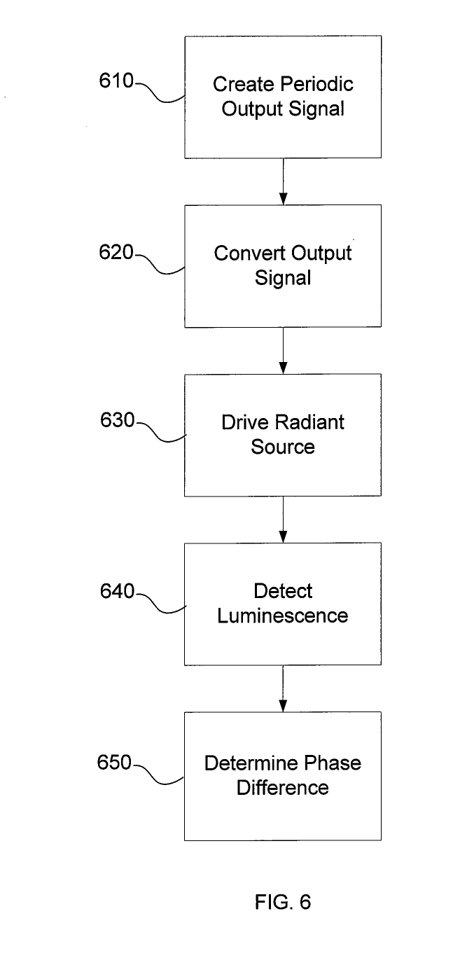

FIG. 6 illustrates a method of measuring the concentration of an analyte according to one embodiment of the invention. At step 610, a periodic digital output signal is created on a microcontroller digital output bus. For example, a microcontroller can generate a sequence of digital output signals representing a quantized sine wave having a frequency f. The output sequence may include a ramp-up to a DC baseline value followed by a series of quantized sine waves superimposed on the baseline, and a return to standby condition.

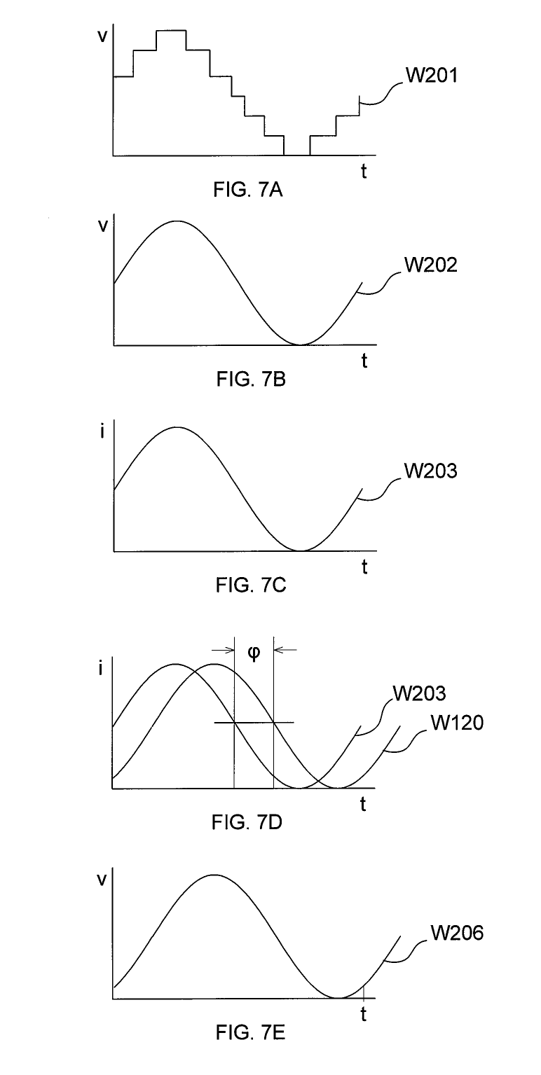

At step 620, the digital output signal of the microcontroller is converted to a smoothed current waveform. This can be achieved by, for example, passing the digital output signal through a digital-to-analog converter to realize voltage waveform W201 as shown in FIG. 7A. FIGS. 7A-7E depict exemplary current or voltage waveforms W201, W202, W203, W240 and W206, respectively, as measured relative to the outputs of components 340, 350, 360, 270, and 400 in FIG. 2, respectively. The origin and scale of time axis t are substantially the same for each of FIGS. 7A-7E. These waveforms illustrate a path through which the signal passes as the signal passes from a digital output, to an analog voltage sine wave, to an analog current sine wave, through a light-emitting diode (LED) and phase detector, to a phase-shifted current sine wave, to a phase-shifted voltage sine wave, and then to an analog-to-digital converter for oversampling.

Voltage waveform W201 may be transmitted through a low-pass filter to smooth the piecewise linear waveform into voltage varying sine wave W202 as shown in FIG. 7B. Voltage varying sine wave W202 may then be transmitted through a voltage-to-current converter to produce current varying sine wave W203 as shown in FIG. 7C.

At step 630, the smoothed current waveform is used to drive the radiation source. That is, current varying sine wave W203 drives a radiant source that excites indicator molecules from which the photoluminescence is incident upon and is transduced by a photoelectric transducer.

At step 640, the luminescent radiation of the indicator molecules, for example, is detected. That is, a photoelectric transducer produces an excitation signal, current waveform W120 as shown in FIG. 7D. Current waveform W120 has the same sine waveform, only phase delayed, as waveform W203. This phase delay φ is a function of the decay time of the luminescent transduction, which is dependent on the concentration of the analyte to which indicator molecules are exposed.

Current from a photoelectric transducer may be transmitted through a bandpass transimpedance amplifier. The bandpass transimpedance amplifier generates voltage waveform W206 as shown in FIG. 7E. The bandpass gain is used to filter noise and is peaked as passing a signal of frequency f.

At step 650, the phase difference between the smoothed current waveform and the photoelectric transducer output waveform is determined. Voltage waveforms W202 and W206 may be used to drive analog inputs of a microcontroller. Internally, each analog input of the microcontroller drives an analog-to-digital converter. Under the control of the microcontroller, voltage waveforms W202 and W206 are digitally oversampled to derive phase delay φ with respect to the excitation signal.

Internally, under the control of a microcontroller program, the microcontroller performs measurements over multiple complete sinusoidal cycles of waveforms W206 and W202. In one embodiment, the measurements are averaged by the microcontroller to produce a measurement of a radiation source drive and a response from indicator molecules. The measurements are normalized for amplitude and DC offset to produce a drive sinusoid and a response sinusoid. A phase difference φ between the two sinusoids provides a measurement of the delay in the response of the circuit to the excitation. The delay is a composite of electronic delay and the decay time, which is a function of the analyte concentration bound to the indicator molecules. For example, the decay time of the photoluminescence at room temperature and 21% O₂ is measured as 4.8 μs.

The local oversampled data from waveforms W202 and W206 are measured for phase using an iterative algorithm. The iterative algorithm, which is part of the microcontroller program, iterates over successive degrees of possible phase. For example, a pair of successive values that bracket the phase of the signal are identified. Then the phase of the signal is estimated by interpolation between the two bracketing phase values. Methods other than linear interpolation may also be used. For example, a sine function may produce accurate estimates of the final phase value. This is because the iterative algorithm determines a zero-crossing of an error value or a match metric. The algorithm interpolates between the values bracketing the data measured by a positive/negative sign change.

In one embodiment, a match metric for the iterative algorithm is a product of 1) the input signal, 2) the estimator, generated for a sequence of arbitrary phase delay step values, and 3) a weighting function, integrated over an interval. In one embodiment, the integration interval is −π to π, and the weighting function is the cosine of an estimator phase value. The estimator phase value may be a dummy variable that describes a phase angle of the estimator and the weighting function. The weighting function emphasizes the signal near the zero-crossing of the estimator function. This improves the discrimination of the phase measurement while reducing the effects of noise and variation in gain or photoluminescence amplitude.

Any metric which is an odd function will work as a match metric for the iterative algorithm. In principle, any cosⁿ function of the estimator phase value for any value of n may serve as a weighting function. Higher cosine powers may improve the signal-to-noise ratio of the phase discrimination. Other weighting functions may also be used.

The phase difference φ bears a relationship to the analyte concentration local to the sensor chemistry (e.g., indicator molecules). Neglecting any spatial distribution within the depth of the chemistry which may be attributed to diffusion, phase difference φ represents the instantaneous analyte concentration at a point at the time of measurement. The measured phase difference φ will vary according to the Stern-Volmer relationship as discussed above. This results from the underlying relationship that both amplitude and decay-time constant (τ) of the sensor chemistry vary according to this relationship.

For a sinusoidal excitation such as that shown in FIG. 7C, the decay-time constant translates directly into a phase delay. The decay-time variation, and hence phase difference φ, will be governed by the Stern-Volmer relationship independent of the loss of amplitude resulting from reaction of the sensor chemistry with the analyte. Provided the received signal amplitude from the sensor chemistry (e.g., indicator molecules) is sufficiently above noise to allow convergence of the phase detection algorithm, the sensor interface module yields a phase measurement. This is a distinct advantage over an amplitude-based sensor, which, in the case of, for example, an amplitude-based optical oxygen sensor, requires separation of the photooxidation and oxygen concentration contributions to the measured amplitude. However, at the end-of-life of sensors embodying the invention, the variation from measurement to measurement will become increasingly noisy, then random. A threshold may be set for this measured variation to indicate a sensor replacement warning.

In operation, commands may be sent from an external device to a microcontroller through a communications channel instructing the microcontroller to collect data. Then data may be retrieved by the external device. A temperature measurement can also be transmitted. The external device may measure timing, communicate with a sensor interface module, and display or use the measured data.

During standby, a radiation source and a photoelectric transducer are not driven. Short, programmed sequences for driving the sensor may be used to greatly reduce the duty cycle of the sensor, in turn reducing sensor chemistry reactivity with the analyte and prolonging sensor life.

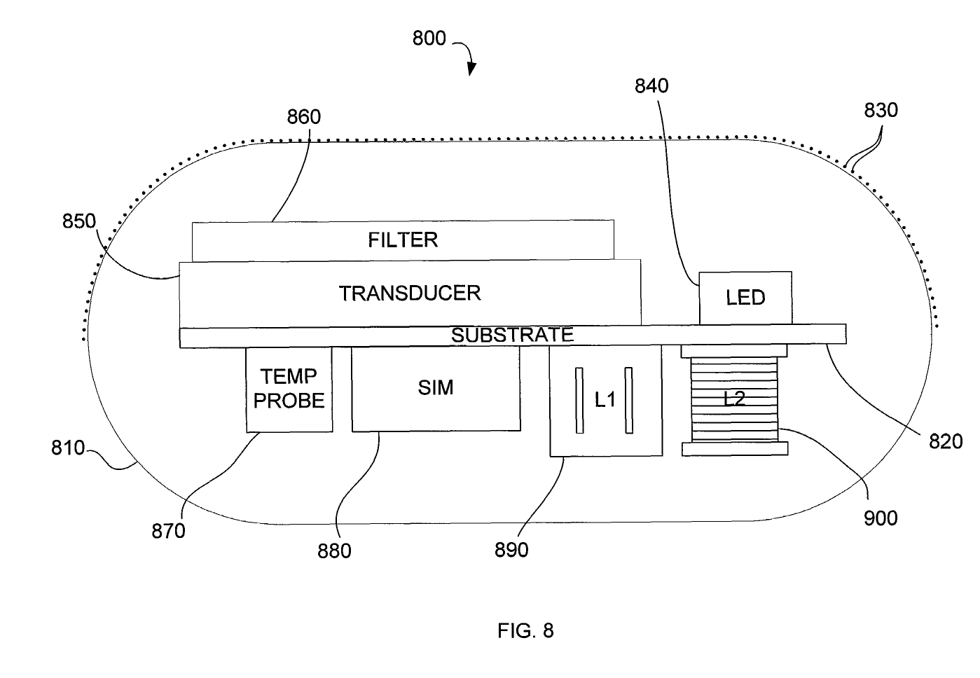

FIG. 8 illustrates an optical sensor 800 according to one embodiment of the invention. Optical sensor 800 has a sensor body 810 and a substrate 820. In one embodiment, sensor body 810 may be coated with indicator molecules 830 or sensor body 810 may be comprised of multiple layers, one of which comprises a matrix layer (not shown) containing indicator molecules 830. Indicator molecules 830 are exposed to (e.g., are local to) a desired environment for sensing an analyte. Optical sensor 800 may be, for example, bean-shaped or pharmaceutical capsule-shaped and of a like size, permitting in-vivo or other in-situ deployment.

Mounted on substrate 820 is a radiation source 840, e.g., a light-emitting diode (LED), that emits radiation over a range of wavelengths that interacts with indicator molecules 830. For example, in the case of a photoluminescence-based sensor, a wavelength that causes indicator molecules 830 to luminesce may be used. Also mounted on substrate 820 is a photoelectric transducer 850, which may be, for example, a photodetector or photodiode. In the exemplary case of a photoluminescence-based sensor, photoelectric transducer 850 is sensitive to photoluminescent light emitted by indicator molecules 830 such that a signal is generated in response thereto that is indicative of the level of photoluminescence of indicator molecules 830.

Radiation source 840, photoelectric transducer 850, and indicator molecules 830 are situated relative to each other such that radiation emitted from radiation source 840 is incident on indicator molecules 830 and radiation, e.g., photoluminescence, from indicator molecules 830 is incident on photoelectric transducer 850. Radiative incidence may occur after reflection and/or transmission through a medium. In one embodiment, an optical filter 860 may be used to limit radiation reaching photoelectric transducer 850 to wavelengths associated with the indicator molecules' response to radiation emitted by radiation source 840.

Optical sensor 800 may also include: a temperature probe 870 for measuring the temperature local to optical sensor 800; sensor interface module (SIM) 880 for generating signals transmitted to radiation source 840 and receiving signals from photoelectric transducer 850; a transmitter 890 for communicating wirelessly with an external system (not shown); and a power source 900 that may include an inductor through which a current may be induced by exposing power source 900 to an appropriate electromagnetic field. Examples of oxygen sensors that may be used according to the invention are described in U.S. Pat. Nos. 5,517,313 and 6,940,590 which are hereby incorporated by reference in their entirety.

According to one embodiment, the accuracy of the analyte concentration measurement may be increased by correcting the measured phase differences based on configuration parameters. One calibration step is to determine the electronic delay, or offset null configuration parameter. Offset null accounts for unit-to-unit variations, primarily due to electronic component tolerances. Determination of offset null can be accomplished at a fixed temperature and analyte concentration at time of manufacture of the optical sensor or during sensor configuration.

Another calibration step is to measure phase difference at known analyte concentrations and various temperatures, fixing other sensor environmental factors such as relative humidity and pressure to known values. In this calibration step, the phase difference is determined as discussed above and values of actual analyte concentrations may be derived from first principles or measured empirically. In practice, there may be some combination of these approaches, especially in applications requiring higher degrees of accuracy. Calibration may be performed on individual devices, a particular SIM/sensor architecture or other basis.

Because the phase difference versus analyte concentration/temperature relationship is not strictly linear in some applications, a transfer function based on these two configuration steps is derived. Both the offset null and temperature correction table comprising a portion of the transfer function could be placed in a table external to a microcontroller or loaded into a memory storage table on a sensor interface module. For applications requiring high accuracy, other psychrometric input variables such as pressure and humidity could be considered in additional calibration steps and the transfer function would include these variables as well.

The sensors described herein are not limited to oxygen sensors. For example, battery-powered, metabolic and atmospheric sensors may be used. Also, the sensors according to the invention may be implanted into a person and used to measure various biological analytes in the human body (e.g., oxygen, carbon dioxide, glucose, toxins). Additionally, the invention described herein may be used in various applications and operating environments. For example, the invention may be used with gas mixing, inerting, dissolved oxygen, environmental rate-of-change, biochemical oxygen demand (BOD), reaction monitors, heating/ventilation/air-conditioning (HVAC) systems, combustion monitoring, and fermentation feed and off gas monitors.

One example of how the sensor and sensor interface module (SIM) according to one embodiment of the present invention can be used in a biochemical oxygen demand (BOD) application relates to wastewater monitoring. Oxidizable material present in a natural waterway or in industrial wastewater is oxidized both by biochemical (bacterial) or chemical processes. The result is that the oxygen content of the water is decreased. Basically, the reaction for biochemical oxidation may be written as:

Oxidizable material+bacteria+nutrient+O2→CO2+H2O+oxidized inorganics such as NO3 or SO4

From this equation, where bacteria and oxygen are on the left, by monitoring the change in oxygen concentration, the rate of this overall reaction, which is directly proportional to the bacteria present, is effectively monitored.

Since all natural waterways contain bacteria and nutrient, almost any waste compounds introduced into such waterways initiate biochemical reactions (such as the reaction shown above). Those biochemical reactions create what is measured as biochemical oxygen demand (BOD).

One of the most commonly measured constituents of wastewater is the biochemical oxygen demand. Wastewater is composed of a variety of inorganic and organic substances. Organic substances refer to molecules that are based on carbon and include, for example, fecal matter as well as detergents, soaps, fats, greases etc. These large organic molecules are easily decomposed by bacteria. However, oxygen is required for this process of breaking large molecules into smaller molecules and eventually into carbon dioxide and water. The amount of oxygen required for this process is known as the biochemical oxygen demand (BOD). In one example, the Five-day BOD, or BOD5, is measured by the quantity of oxygen consumed by microorganisms during a five-day period, and is the most common measure of the amount of biodegradable organic material in, or strength of, sewage.

BOD has traditionally been used to measure of the strength of effluent released from conventional sewage treatment plants to surface waters or streams. This is because sewage high in BOD can deplete oxygen in receiving waters, causing fish kills and ecosystem changes. In one non limiting example, based on criteria for surface water discharge, the secondary treatment standard for BOD has been set at 30 mg BOD/L (i.e. 30 mg of O2 are consumed per liter of water over 5 days to break down the waste).

In one example of a biological oxygen demand (BOD) application, the sensor and sensor interface module (SIM) described herein may be placed in a suitable location relative to the wastewater or other medium to make desired measurements such as, for example, to monitor the change in oxygen concentration.

The sensor and sensor interface module (SIM) according to the invention may also be used to measure temperature. For example, the complex tris (4,7-diphenyl-1,10-phenanthroline) ruthenium(II) perchlorate may be used as the indicator molecule and embedded within a material such as plastic or glass or a sensor overall encased within a metal housing generally impervious to oxygen. The indicator molecule is irradiated which causes luminescence. At a fixed oxygen concentration, the luminescence changes as a function of time (i.e. temperature, luminescence is greater at lower temperatures and smaller at higher temperatures), and is detected by the sensor. The temperature can be determined based on the change in luminescence or phase from the SIM.

While various embodiments/variations of the invention have been described above, it should be understood that they have been presented by way of example only, and not limitation. Thus, the breadth and scope of the invention should not be limited by any of the above-described exemplary embodiments, but should be defined only in accordance with the following claims and their equivalents.

What is claimed is:

1. A device for measuring analyte concentration comprising:
a sensor, said sensor comprising at least one indicator molecule in communication with a transducer;
a sensor interface module in communication with the sensor, wherein the sensor interface module comprises a microcontroller; and
wherein the sensor interface module facilitates time domain measurement of excitation emission of said at least one indicator molecule.

2. The device of claim 1, wherein the sensor is an optical sensor.

3. The device of claim 2, wherein the optical sensor comprises a radiation source.

4. The device of claim 3, wherein the radiation source comprises a light-emitting diode (LED).

5. The device of claim 4, wherein the LED comprises any one of a blue LED, violet LED, and red LED.

6. The device of claim 1, wherein the sensor interface module comprises an interface that enables communication between the sensor and the sensor interface module.

7. The device of claim 6, wherein the interface comprises an analog interface.

8. The device of claim 1, further comprising an external data system.

9. The device of claim 8, further comprising an interface that enables communications between the sensor interface module and the external data system.

10. The device of claim 1, wherein the at least one indicator molecule comprises any one of complex tris (4,7-diphenyl-1,10-phenanthroline) ruthenium(II) perchlorate, a lanthanide-based indicator, and aromatic hydrocarbons.

11. The device of claim 10, wherein the lanthanide-based indicator comprises any one of europium and terbium complexes.

12. The device of claim 1, wherein the at least one indicator molecule is adjacent to the sensor.

13. The device of claim 1, wherein the sensor and the sensor interface module are capable of being provided on and communicate using a circuit board.

14. A method of measuring a concentration of an analyte comprising:
selecting a sensor;
providing an indicator molecule adjacent the sensor;
generating a stimulus waveform based on the analyte;
exciting the indicator molecule;
detecting a characteristic of the analyte based on its response characteristic to the indicator molecule excited; and
determining the analyte concentration.

15. The method of claim 14, wherein the generating a stimulus waveform comprises approximating a voltage waveform as a sine wave.

16. The method of claim 14, further comprising oversampling the stimulus waveform and the response waveform.

17. The method of claim 14, further comprising determining a phase delay between the stimulus waveform and the response waveform.

18. The method of claim 14, wherein the exciting the indicator molecules comprises irradiating the indicator molecules.

19. The method of claim 17, further comprising detecting a photoluminescent radiation of the indicator molecules.

20. The method of claim 14, wherein the selecting a sensor comprises selecting an optical sensor.

21. The method of claim 14, further comprising driving a radiant source with the stimulus waveform.

22. A device for measuring an analyte concentration comprising:
a microcontroller configured to output a periodic digital signal of a predetermined frequency and compute a phase difference between a stimulus waveform and a response waveform;
a digital-to-analog converter operable to convert the periodic digital signal to a periodic voltage waveform;
a low pass filter operable to smooth the periodic voltage waveform and output the stimulus waveform;
a voltage-to-current converter operable to convert the stimulus waveform to a periodic current waveform and to drive a radiant source, wherein the radiant source radiates onto indicator molecules; and
a bandpass transimpedance amplifier operable to convert a current from a photoelectric transducer to the response waveform, wherein radiation from the indicator molecules is incident on a photoelectric transducer;
wherein the phase difference is a function of an analyte concentration local to the indicator molecules.

23. The device of claim 21, wherein the periodic digital signal has a frequency in a range of 9 kHz to 11 kHz.

24. The device of claim 21, wherein the microcontroller is further configured to serially communicate a parameter related to computation of analyte concentration with an apparatus external to the device.

25. The device of claim 21, wherein the device is in communication with an external device.

26. The device of claim 24, wherein the external device comprises a data collection system.

27. The device of claim 21, wherein the radiant source comprises a light-emitting diode.

28. The device of claim 21, wherein the microcontroller is further configured to output the periodic digital signal on the digital output bus as follows:
(a) the microcontroller waits to receive an instruction to take concentration data; said instruction transmitted to a serial input port of the microcontroller;
(b) the microcontroller outputs a ramp signal on the digital output bus;
(c) the microcontroller outputs a signal representing a quantized sine wave at a predetermined frequency on the digital output bus; and
(d) the microcontroller sets the digital output bus to a standby value.

29. The device of claim 21, wherein the microcontroller is further configured to convert the phase difference to an analyte concentration value using a transfer function.

30. The device of claim 28, wherein the transfer function comprises dependent variables of any one of temperature, pressure, and humidity.

31. An analyte concentration sensor comprising:
the device of claim 21, wherein the device is adjacent an analyte.

32. The analyte concentration sensor according to claim 30, wherein the analyte is O₂, the radiant source comprises an LED, the photoelectric transducer comprises a photodiode, and the indicator molecules exhibit photoluminescent quenching in the presence of O₂.

33. A method of determining the concentration of an analyte, the method comprising:
creating a periodic digital output signal on a microcontroller output;
converting the periodic digital output signal into a smoothed driver current waveform, said smoothed driver current waveform being of the same frequency as the periodic digital output signal;
driving a radiant source with said smoothed driver current, wherein radiation from the radiant source is incident on indicator molecules;
detecting radiant excitance of the indicator molecules with a photoelectric transducer, wherein the photoelectric transducer outputs a waveform of the same frequency as the smoothed driver current waveform; and
measuring a phase difference between the smoothed driver current waveform and the outputted photoelectric transducer waveform;
wherein the phase difference correlates to an analyte concentration local to the indicator molecules.

34. The method of claim 32, wherein the analyte is O₂, the radiant source comprises an LED, the photoelectric transducer comprises a photodiode, and the indicator molecules exhibit photoluminescent quenching in the presence of O₂.

35. A method of measuring a concentration of an analyte comprising:
selecting a sensor;
providing an indicator molecule adjacent the sensor;
generating a stimulus waveform based on the analyte;
exciting the indicator molecule;
detecting a characteristic of the analyte based on its response characteristic to the indicator molecule excited; and
determining the analyte concentration.

36. The method of claim 34, further comprising oversampling the stimulus waveform and the response waveform.

37. The method of claim 34, further comprising determining a phase delay between the stimulus waveform and the response waveform.

38. The method of claim 34, wherein the exciting the indicator molecules comprises irradiating the indicator molecules.

39. The method of claim 37, further comprising detecting a photoluminescent radiation of the indicator molecules.

40. The method of claim 34, wherein the selecting a sensor comprises selecting an optical sensor.

41. The method of claim 34, further comprising driving a radiant source with the stimulus waveform.

42. A method of determining a presence of oxygen within a medium, comprising:
selecting an oxygen sensor;
providing the sensor with an indicator molecule;
locating the sensor within a medium;
transmitting a phase modulated signal to the sensor from a sensor interface module;
determining a rate of change of the phase modulated signal; and
determining a concentration of oxygen within the medium.

43. The method of claim 41, wherein the medium comprises any one of water, blood, and air.
